(19) United States
(12) Patent Application Publication
(10) Pub. No.: US 2025/0230025 A1
(43) Pub. Date: Jul. 17, 2025

(54) DUMP-BIN APPARATUSES AND RELATED METHODS

(71) Applicant: ACE MACHINING LIMITED, Dartmouth (CA)

(72) Inventors: Andrew RACE, Dartmouth (CA); Ronald WALLACE, Fall River (CA)

(21) Appl. No.: 19/020,104

(22) Filed: Jan. 14, 2025

Related U.S. Application Data
(60) Provisional application No. 63/621,298, filed on Jan. 16, 2024.

(51) Int. Cl. B66F 9/19; B66F 9/18

(52) U.S. Cl. CPC B66F 9/19; B66F 9/187

(57) ABSTRACT

A dump-bin apparatus for waste transfer includes (a) a frame mountable to forks of a forklift; (b) a bin retainer pivotably mounted to the frame for securely retaining a dump bin, the bin retainer pivotable relative to the frame between an upright position and a dumping position; and (c) a release mechanism locking the bin retainer to the frame in the upright position. The release mechanism includes an actuator operable to release the bin retainer from the frame for pivoting toward the dumping position through pushing of the actuator in a forward direction away from the forklift when the frame is mounted to the forklift.

### CROSS-REFERENCE TO RELATED APPLICATION(S)

This application claims the benefit of U.S. Provisional Patent Application No. 63/621,298 filed on Jan. 16, 2024, which is hereby incorporated herein by reference in its entirety.

### FIELD

The present disclosure relates generally to material transfer, and more specifically, to dump-bin apparatuses and related methods for waste transfer.

### INTRODUCTION

U.S. Pat. No. 5,306,110 (Cline) discloses an apparatus for dumping the contents of a container, for example, a drum. The apparatus includes a first frame for receiving tines of a fork lift, a second frame for receiving a drum pivotally mounted on the first frame and a latch secured to the second frame. The latch is held by a normally extended spring in a first position latching the first frame and the second frame together. The latch includes a latch pin which extends downward below the bottom of the drum when the drum is raised from the ground for emptying. The raised drum is moved forward into position so that the latch pin engages an upper edge of a receptacle for receiving contents of the drum. As the raised drum is moved further forward with the latch pin still engaging the upper edge of the receptacle, the latch moves into a second position compressing the spring and releasing the second frame from latched engagement with the first frame. This allows the drum to pivot on the first frame to an inverted position for emptying. The inverted drum is moved rearward until its open edge strikes the upper edge of the receptacle and the drum is rotated thereabout until it regains an upright latched position.

U.S. Pat. No. 3,506,148 (Vik) discloses a gravity actuated self-righting dumper for containers such as steel and fiber drums and other open-top shipping containers. The dumper consists of a supporting framework, a pair of clamp arms, a pair of jaws on the arms for engaging and supporting the load that is to be dumped, a laterally disposed pivot operatively associated between the clamp arms and the supporting framework in a position with respect to the container when mounted between the jaws such that the weight of the container will cause the clamp arms and the container itself to tip forwardly about the pivot thereby dumping the contents of the container. A spring that is connected between the supporting frame work and the jaws returns the container to the upright position. A latch mechanism retains the jaws in a horizontal position until released.

International App. Pub. No. WO 2004/022455 (Alasuutari) discloses a container for emptying by a forklift truck or equivalent characterised in that an arrangement for tipping a receptacle comprises as a combination: a first tipping arm attached pivotally to the base and to the upper part of the receptacle adjacent to the rear side thereof; a second tipping arm attached pivotally to a structure at the front side of the base and to the receptacle so that at the idle state of the container it is directed up and backwards from the base to the receptacle; and a lever arm with a pivotal attachment to the base, the first end of the lever arm extending below the base and the second end being for setting it against the first tipping arm, whereby turning the first end of the lever arm backwards causes the first and second tipping arms to turn forward and consequently the receptacle first to lift off from the base and then to tip.

### SUMMARY

The following summary is intended to introduce the reader to various aspects of the applicant's teaching, but not to define any invention.

According to some aspects, a dump-bin apparatus for waste transfer includes: (a) a frame extending along a horizontal frame axis between a front and a rear of the frame. The frame includes a pair of laterally spaced apart channels extending along the frame axis. Each channel has an open end at the rear of the frame for receiving a respective fork of a forklift for mounting the dump-bin apparatus to the forklift. The apparatus further includes (b) a bin retainer pivotably mounted to the frame for retaining a dump bin having an open top. The bin retainer is pivotable relative to the frame about a lateral axis extending perpendicular to the frame axis between an upright position for supporting the dump bin upright with the open top directed generally upwardly for receiving waste in the dump bin, and a dumping position for inverting the dump bin to direct the open top generally downwardly for dumping the waste out from the dump bin into a waste receptacle. The apparatus further includes (c) a release mechanism including a latch movable between a locked position for locking the bin retainer relative to the frame in the upright position and an unlocked position for unlocking the bin retainer relative to the frame to permit pivoting of the bin retainer from the upright position to the dumping position. The release mechanism further includes an actuator for operating the latch to unlock the bin retainer. The actuator has an input end directed rearwardly toward the forklift. The input end is pushable in a forward direction toward the front of the frame through engagement with an inner surface of the waste receptacle during reverse operation of the forklift away from the waste receptacle to move the latch from the locked position to the unlocked position.

In some examples, the release mechanism is mounted to the frame, and the bin retainer has a catch interlockable with the latch when the bin retainer is in the upright position to lock the bin retainer to the frame. The latch is clear of the catch when in the unlocked position to permit pivoting of the bin retainer toward the dumping position.

In some examples, the input end of the actuator has an engagement surface at an elevation below the pair of channels for lowering into the waste receptacle into vertical alignment with the inner surface of the waste receptacle.

In some examples, the input end of the actuator is rearward of the bin retainer and adjacent the rear of the frame.

In some examples, the input end of the actuator projects rearwardly from the rear of the frame.

In some examples, input end is pushable from a rearward position in which the latch is in the locked position to a forward position in which the latch is in the unlocked position.

In some examples, the release mechanism is spring-loaded and has at least one return spring biasing the latch toward the locked position and the input end of the actuator toward the rearward position to automatically reset the release mechanism when the dump bin is moved from the dumping position back into the upright position.

In some examples, the actuator has an actuator bar extending parallel with the frame axis between and connecting the input end and the latch, the actuator bar slidably coupled to the frame for sliding along the frame axis to move the latch in response to movement of the input end of the actuator.

In some examples, the latch is fixed adjacent a front end of the actuator bar and the input end is fixed adjacent a rear end of the actuator bar opposite the front end.

In some examples, when the dump bin is mounted to the bin retainer, the dump bin and bin retainer together have a center of gravity offset forward of the lateral axis to initiate pivoting of the bin retainer from the upright position toward the dumping position under gravity when the latch is moved to the unlocked position.

In some examples, the dump bin is a standard size drum.

In some examples, the apparatus further includes a plurality of wheel assemblies projecting downwardly from an underside of the frame to facilitate transport of the dump-bin apparatus along a ground surface when dismounted from the forklift.

In some examples, the dump bin is mounted to the bin retainer, and includes a fluid drainage system for draining fluid waste from the dump bin while retaining solid waste. In some examples, the fluid drainage system comprises a drain port adjacent a bottom end of the dump bin. In some examples, the fluid drainage system comprises a filter screen extending across and separating an interior of the dump bin into an upper portion above the filter screen for retaining the solid waste and a lower portion below the filter screen and in fluid communication with the drain port for receiving the fluid waste.

According to some aspects, a dump-bin apparatus for waste transfer includes (a) a frame mountable to forks of a forklift; (b) a bin retainer pivotably mounted to the frame for securely retaining a dump bin, the bin retainer pivotable relative to the frame between an upright position for supporting the dump bin upright, and a dumping position for inverting the dump bin to dump waste out from the dump bin into a waste receptacle; and (c) a release mechanism locking the bin retainer to the frame in the upright position, the release mechanism including an actuator operable to release the bin retainer from the frame for pivoting toward the dumping position through pushing of the actuator in a forward direction away from the forklift when the frame is mounted to the forklift.

According to some aspects, a method of operating a dump-bin apparatus for transferring waste to a waste receptable includes: (a) filling a dump bin of the dump-bin apparatus with waste when in an upright position through an open top of the dump bin; (b) when the dump bin is filled with the waste, operating a forklift to position the dump-bin apparatus over the waste receptacle, with the dump bin retained in the upright position by the dump-bin apparatus; and (c) after (b), operating the forklift to lower the dump-bin apparatus to align an actuator of the dump-bin apparatus with an inner surface of the waste receptacle directed away from the forklift, and reversing the forklift to bring the actuator into engagement with the inner surface and push an input end of the actuator forward relative to the dump bin to release the dump bin for pivoting from the upright position to a dumping position, in which the open top is directed downwardly to dump the waste into the waste receptacle.

In some examples, the dump bin is locked in the upright position through a latch of the release mechanism, and pushing an input end of the actuator forward unlocks the latch to permit pivoting of the dump bin from the upright position to the dumping position.

In some examples, the method further includes (d), after (c), operating the forklift to bring the dump bin into engagement with the waste receptacle to pivot the dump bin back up toward the upright position for a subsequent waste transfer cycle.

In some examples, the waste in (a) comprises solid waste and fluid waste, and prior to (b), at least some of the fluid waste is drained from the dump bin through a drain port adjacent a bottom end of the dump bin, and the solid waste is retained in the dump bin for transfer to the waste receptacle during (c).

### BRIEF DESCRIPTION OF THE DRAWINGS

The drawings included herewith are for illustrating various examples of apparatuses, systems, and processes of the present specification and are not intended to limit the scope of what is taught in any way. In the drawings:

FIG. 1 is a perspective view of an example dump-bin apparatus;

FIG. 2 is a side elevation view of the dump-bin apparatus of FIG. 1, with a dump bin of the apparatus shown in an upright position;

FIG. 3 is an enlarged view of a release mechanism portion of the apparatus of FIG. 2, shown in a locked configuration;

FIG. 4 is an enlarged view like that of FIG. 3, but showing the release mechanism portion in an unlocked configuration;

FIG. 5 is a side elevation view like that of FIG. 2, but showing the bin pivoting toward a dumping position;

FIG. 6 is a rear elevation view of the dump-bin apparatus of FIG. 1;

FIG. 7 is a perspective view of the dump-bin apparatus of FIG. 1, with the bin removed; and

FIGS. 8A-8F are side views of another example dump-bin apparatus similar to that of FIG. 1 mounted to a forklift, and shown at different stages of an example waste transfer process.

### DETAILED DESCRIPTION

Various apparatuses, systems, or processes will be described below to provide an example of an embodiment of each claimed invention. No embodiment described below limits any claimed invention and any claimed invention may cover apparatuses, processes, or systems that differ from those described below. The claimed inventions are not limited to apparatuses, systems, or processes having all of the features of any one apparatus, system, or process described below or to features common to multiple or all of the apparatuses, systems, or processes described below. It is possible that an apparatus, system, or process described below is not an embodiment of any claimed invention. Any invention disclosed in an apparatus, system, or process described below that is not claimed in this document may be the subject matter of another protective instrument, for example, a continuing patent application, and the applicants, inventors, or owners do not intend to abandon, disclaim, or dedicate to the public any such invention by its disclosure in this document.

According to some aspects of the present disclosure, dump-bin apparatuses for transferring material, such as waste, are disclosed. The waste can comprise, for example, metal chips, shavings, or other swarf, byproduct, or waste material. In some examples, the dump-bin apparatus includes a frame and a bin assembly mounted to the frame. The bin assembly can include a dump bin for collecting waste, for example, during or after a machining process (e.g. by positioning the bin under a downstream end of a conveyor from which waste is discharged). After the bin is filled, the dump-bin apparatus can be picked up by a forklift (e.g. by engaging the frame of the apparatus with forks of the forklift), and transported to a larger waste receptacle (e.g. dumpster) to dump the waste from the bin into the waste receptacle. The dump-bin apparatus can include a release mechanism for selectively unlocking the bin assembly from the frame to permit pivoting of the bin when properly positioned over the waste receptacle to dump the waste from the bin into the waste receptacle. Aspects of the dump-bin apparatuses and corresponding methods of the present teachings can, in some cases, facilitate safer, more convenient, cost effective, and/or reliable transfer and dumping of waste relative to some existing waste transfer systems or methods.

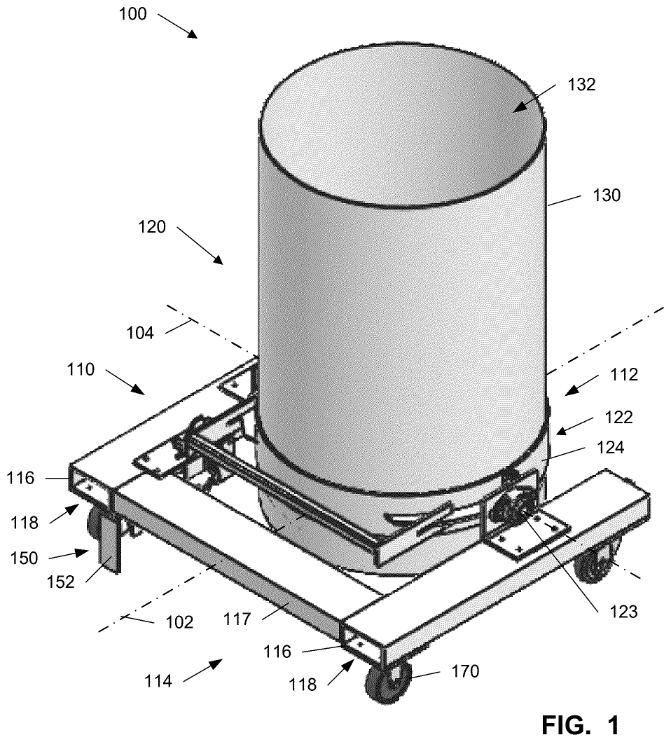

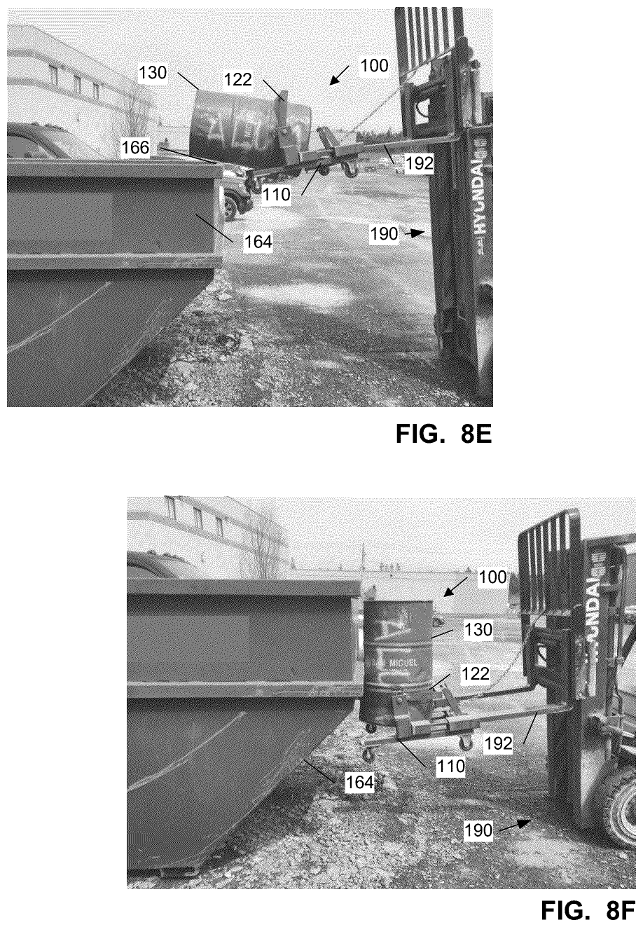

Referring to FIG. 1, a perspective view of an example dump-bin apparatus 100 is shown. In the example illustrated, the apparatus 100 includes a frame 110 mountable to a forklift (e.g. forklift 190 shown in FIG. 8A) and a bin assembly 120 pivotably mounted to the frame 110. The forklift can comprise

In the example illustrated, the frame 110 extends along a horizontal frame axis 102 between a front 112 of the frame 110 and a rear 114 of the frame 110. The frame 110 includes a pair of laterally spaced apart channels 116 extending along the horizontal frame axis 102. Each channel 116 has an open end 118 at the rear 114 of the frame 110 for receiving a respective fork of a forklift (see e.g. forklift forks 192 shown in FIG. 8A) for mounting the dump-bin apparatus 100 to the forklift to permit lifting and transport of the dump-bin apparatus 100 by the forklift. In the example illustrated, the pair of channels 116 comprise tubular frame members extending along the frame axis 102 and fixed to each through one or more cross-members 117 of the frame 110 extending laterally between the pair of channels 116 perpendicular to the frame axis 102.

The dump-bin apparatus 100 can include a restraint for securing the frame 110 to the forklift to prevent the apparatus 100 from sliding off the forks when mounted. The frame restraint can comprise, for example, a fork lock, fork clamp, chain (see e.g. chain restraint 194 in FIG. 8A), or other restraint for securing the frame 110 to the forklift when mounted thereon.

In the example illustrated, the bin assembly 120 includes a bin retainer 122 and a dump bin 130 secured to the bin retainer 122. In the example illustrated, the dump bin 130 has an open top 132 for receiving waste, a closed bottom opposite the open top 132, and a sidewall extending from the closed bottom to the open top 132 and enclosing an interior of the dump bin 130 for containing the waste. The sidewall is cylindrical in the example illustrated. In the example illustrated, the dump bin 130 comprises a standard drum, for example, a standard 30- to 55-gallon drum. In the example illustrated, the bin 130 comprises a standard 45-gallon drum.

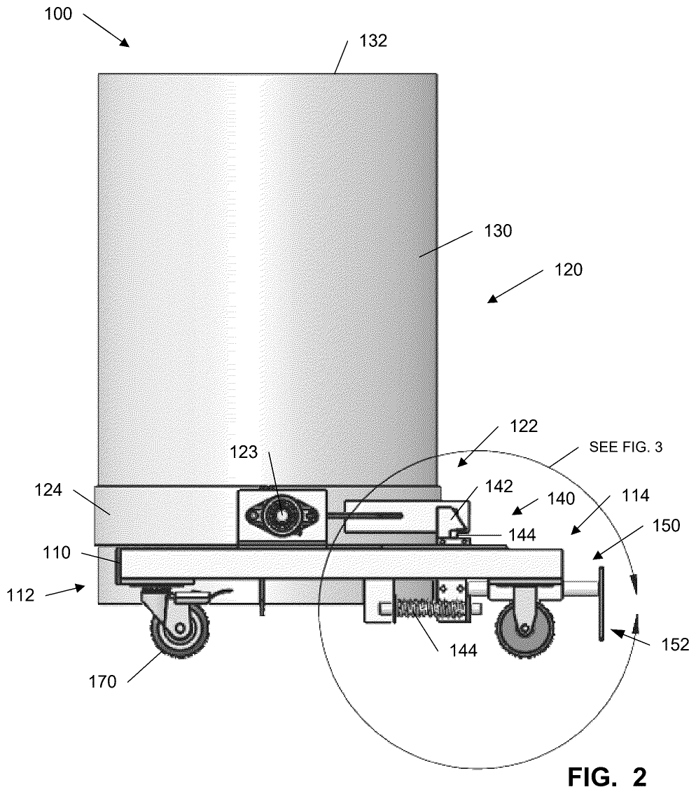

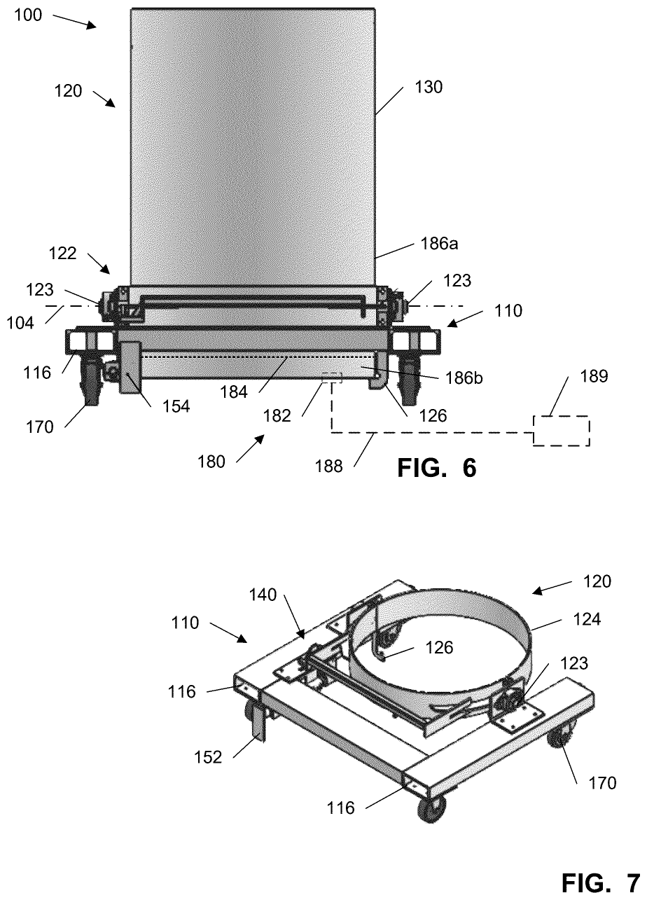

In the example illustrated, the bin retainer 122 is pivotably mounted to the frame 110, and is pivotable relative to the frame 110 about a lateral pivot axis 104 extending perpendicular to the frame axis 102. In the example illustrated, the bin retainer 122 is pivotably mounted to the frame 110 through a pair of pivot pins 123 on laterally opposite sides of the bin retainer 122 and extending coaxial with the lateral axis 104. The bin retainer 122 is pivotable (along with the bin 130 when secured thereto) between an upright position (shown in FIGS. 1 and 2) for supporting the dump bin 130 upright, and a dumping position (shown schematically in dashed lines in FIG. 5) for inverting the dump bin 130 to dump waste out from the dump bin 130. Referring to FIG. 2, in the example illustrated, when the dump bin 130 is upright, the open top 132 of the dump bin 130 is directed generally upwardly for collecting waste in the interior of the bin 130. Referring to FIG. 5, when the dump bin 130 is inverted, the open top 132 of the dump bin 130 is directed downwardly for dumping the waste out from the interior of the dump bin 130. During pivoting of the bin retainer 122 from the upright position toward the dumping position, the open top 132 of the dump bin 130 initially pivots downwardly toward the front 112 of the frame 110 away from the forklift.

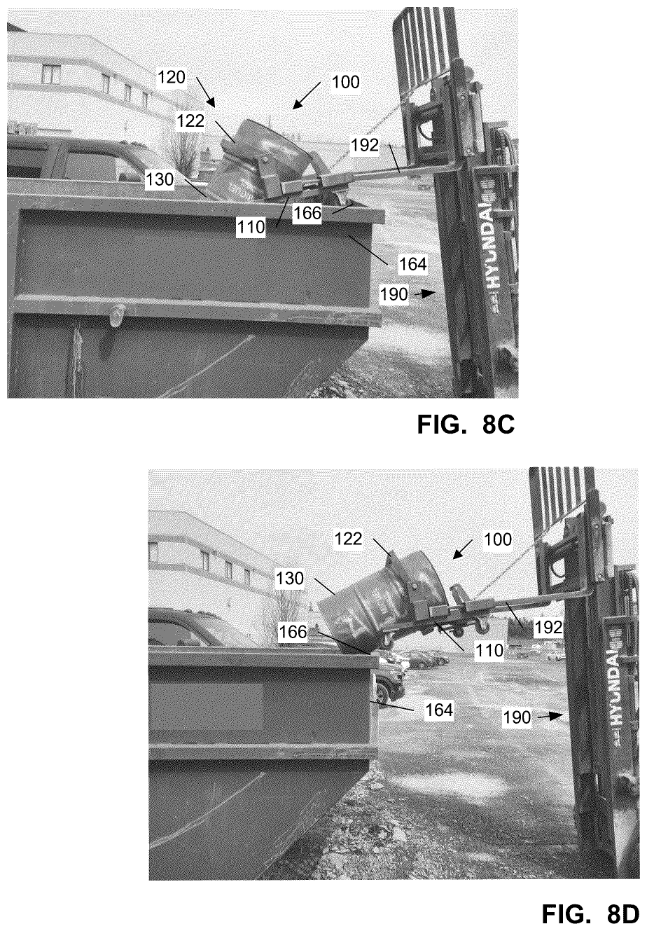

Referring again to FIG. 1, in the example illustrated, the dump bin 130 is removably retained by the bin retainer 122. This can allow users to install their own or different types of bins (e.g. standard drum sizes). In the example illustrated, the bin retainer 122 comprises a collar 124 extending circumferentially about the dump bin 130 for securing the dump bin 130 to the bin retainer 122. The collar 124 can have a clamp mechanism operable to clamp (e.g. tighten) the collar 124 around the dump bin 130 to retain the dump bin 130 in the bin retainer 122, and to unclamp the collar 124 from the dump bin 130 to permit removal of the dump bin 130 from the bin retainer 122. Referring to FIG. 7, in the example illustrated, the collar 124 defines an opening for receiving the bin 130, and the bin retainer 122 further includes one or more stop members 126 fixed relative to the collar 124 and projecting underneath the opening of the collar 124 to support an underside of the bin 130 when received through the collar 124.

In other examples, the dump bin 130 and bin retainer 122 may be formed integrally with each other. For example, in some examples, the bin retainer 122 can comprise pivot pins formed integrally on opposite sides of the dump bin and received in bearings supported by the frame.

Referring to FIG. 2, in the example illustrated, the dump-bin apparatus 100 further includes a release mechanism 140 for locking the bin retainer 122 to the frame 110 in the upright position, and unlocking the bin retainer 122 from the frame 110 to permit pivoting of the bin retainer 122 (and bin 130) toward the dumping position.

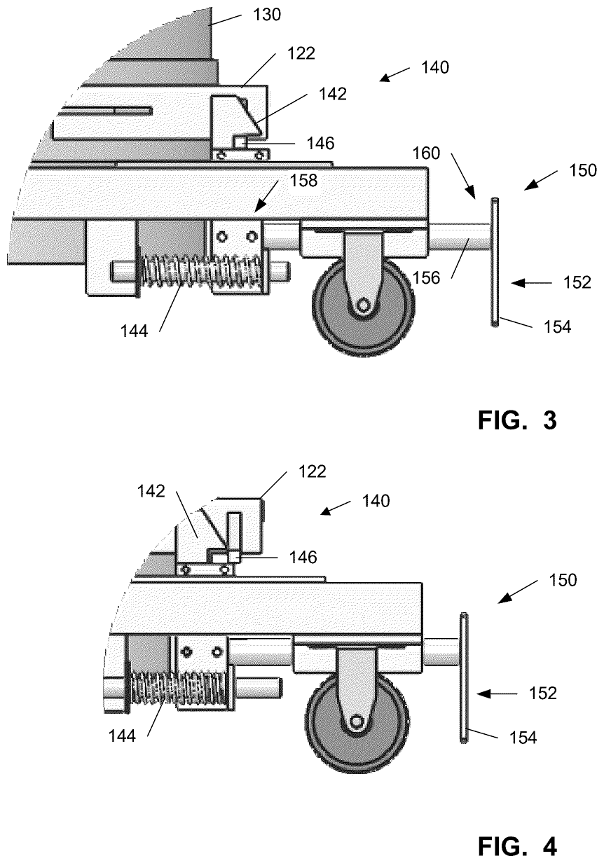

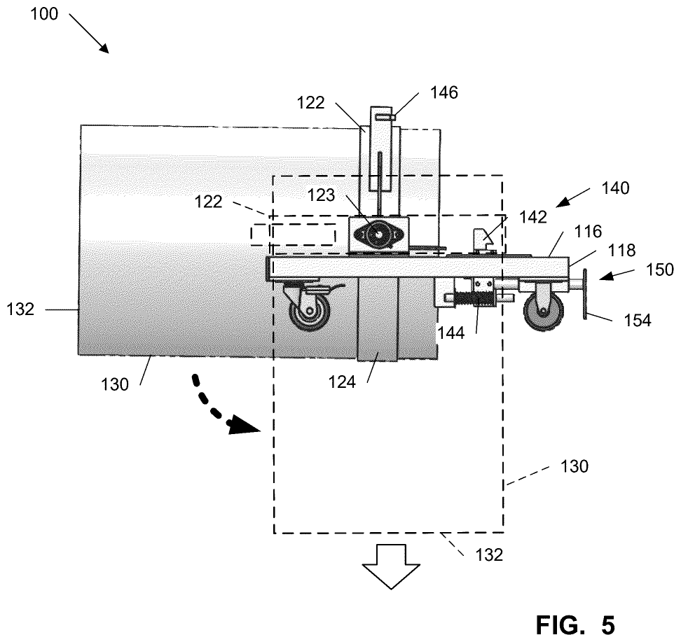

In the example illustrated, the release mechanism 140 includes a latch 142 moveable between a locked position (FIG. 3) and an unlocked position (FIG. 4). Referring to FIG. 3, when the latch 142 is in the locked position with the bin retainer 122 in the upright position, the latch 142 locks the bin retainer 122 to the frame 110 in the upright position. Referring to FIG. 4, when the latch 142 is in the unlocked position, the bin retainer 122 is unlocked from the frame 110 to permit pivoting of the bin retainer 122 from the upright position toward the dumping position. The latch 142 is mounted to one of the frame 110 and the bin retainer 122, and is interlockable with a catch 146 fixed to the other one of the frame 110 and the bin retainer 122 for locking the bin retainer 122 relative to the frame 110 in the upright position. In the example illustrated, the latch 142 is mounted to the frame 110, and the catch 146 is fixed to the bin retainer 122 for interlocking with the latch 142 in the locked position when the bin retainer 122 is in the upright position. The latch 142 is moved clear of the catch 146 when in the unlocked position to permit pivoting of the bin retainer 122 toward the dumping position.

Referring to FIG. 2, in example illustrated, the release mechanism 140 includes an actuator 150 for operating the latch 142 to unlock the bin retainer 122 from the frame 110. In the example illustrated, the actuator 150 is coupled to the latch 142 for moving the latch from the locked position toward the unlocked position to release the bin retainer 122 for pivoting toward the dumping position.

In the example illustrated, the actuator 150 includes an input end 152 directed rearwardly toward the forklift. The input end 152 is pushable in a forward direction toward the front 112 of the frame 110 to move the latch 142 to the unlocked position for releasing the bin retainer 122. In the example illustrated, the input end 152 of the actuator 150 is pushable from a rearward position in which the latch 142 is in the locked position to a forward position toward the front 112 of the frame 110 and in which the latch 142 is in the unlocked position. The input end 152 is positioned for engagement with an inner surface (e.g. adjacent an upper edge) of a waste receptacle (e.g. waste receptacle 164 shown in FIG. 8A) directed away from the forklift and toward an interior of the waste receptacle. The input end 152 is engageable with the inner surface during reverse operation of the forklift away from the waste receptacle, which can improve safety by, for example, preventing accidental release of the bin retainer 122 during forward operation of the forklift.

In the example illustrated, the input end 152 of the actuator 150 is positioned rearward of the dump bin 130, and is adjacent the rear 114 of the frame 110. This can help improve safety by requiring the bin retainer 122 and dump bin 130 to be positioned overtop of the waste receptacle prior to the input end 152 of the actuator 150 being engageable with the interior of the waste receptacle for moving the latch 142 to the unlocked position to release the bin retainer 122. In the example illustrated, the input end 152 projects rearwardly from the rear 114 of the frame 110.

Referring to FIG. 3, in the example illustrated, the input end 152 of the actuator 150 comprises a paddle. In the example illustrated, the paddle is oriented generally vertically and has an engagement surface 154 directed rearwardly at an elevation below the pair of channels 116 (and forks of the forklift). This can allow for the engagement surface 154 to be lowered into vertical alignment with the inner surface of the waste receptacle, without interference from the frame 110 or forks of the forklift.

In the example illustrated, the release mechanism 140 is spring loaded and includes at least one return spring 144 for biasing the release mechanism 140 in the locked position and automatically resetting the release mechanism 140 when the dump bin 130 is moved back into the upright position. In the example illustrated, the return spring 144 biases the latch 142 toward the locked position and the input end 152 of the actuator 150 toward the rearward position.

In the example illustrated, the actuator 150 comprises an actuator bar 156 extending parallel with the frame axis 102 between, and connecting, the input end 152 of the actuator 150 and the latch 142. In the example illustrated, the actuator bar 156 is slidably coupled to the frame 110 for sliding along the frame axis 102 to move the latch 142 in response to movement of the input end 152 of the actuator 150 between the rearward and forward positions. In the example illustrated, the actuator bar 156 extends between a front end 158 toward the front 112 of the frame 110 and a rear end 160 toward the rear 114 of the frame 110. The latch 142 is fixed adjacent the front end 158 of the actuator bar 156 and the input end 152 of the actuator 150 is fixed adjacent a rear end of the actuator bar 156. In the example illustrated, the return spring 144 comprises a compression spring held axially captive between a first surface fixed relative to the frame 110 and a second surface fixed relative to the actuator bar 156 for pushing the actuator bar toward the rear 114 of the frame 110 to bias the latch 142 toward the locked position and the input end 152 of the actuator 150 toward the rearward position.

Referring to FIG. 1, in the example illustrated, when the dump bin 130 and the bin retainer 122 are in the upright position, the bin assembly 120 has a center of gravity offset forward of the lateral axis 104 (toward the front 112 of the frame 110) to initiate pivoting of the bin retainer 122 and the dump bin 130 toward the dumping position under gravity when the bin retainer 122 is released (unlocked) from the frame 110. In the example illustrated, the collar 124 is generally annular, and when the bin retainer 122 is in the upright position, the collar 124 has a geometric center forward of the lateral axis 104 to provide the offset center of gravity to facilitate pivoting of the bin retainer 122 and bin 130 under gravity. In other examples, the geometric center of the collar 124 may be in alignment with the lateral axis 104, and the offset center of gravity may be provided through a different mechanism, such as, for example, a sloped floor in the dump bin 130 that slopes downwardly toward the front 112 of the frame 110 to offset the center of mass of the waste held in the dump bin 130 forward of the lateral axis 104.

In the example illustrated, the dump-bin apparatus 100 includes a plurality of wheel assemblies 170 projecting downwardly from the frame 110 for rolling engagement with a ground surface. The wheel assemblies 170 facilitate transport of the dump-bin apparatus 100 along a ground surface when dismounted from the forklift—for example, to maneuver and position the bin 130 under a discharge end of a waste collection system. In the illustrated embodiment, the dump-bin apparatus 100 has four wheel assemblies 170, one in each corner of the frame 110.

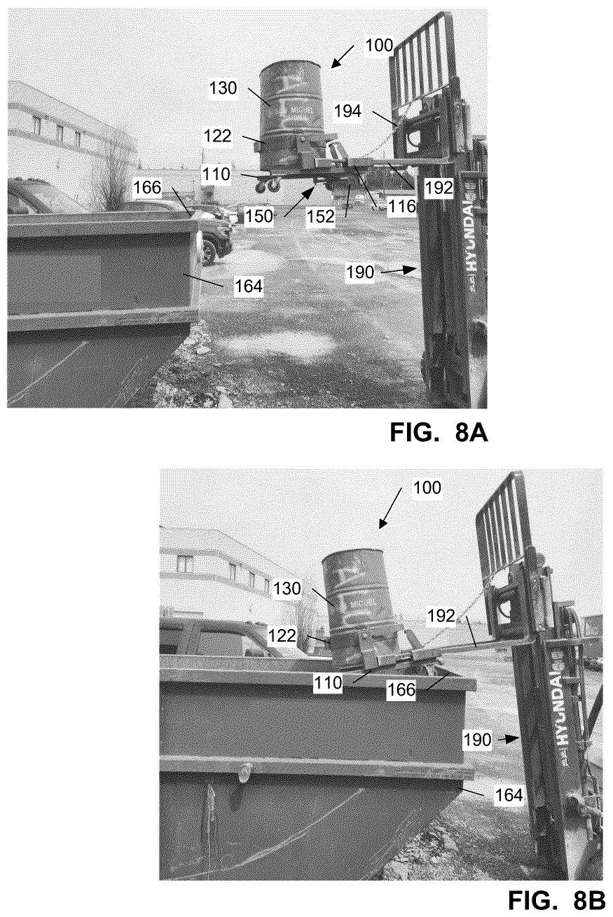

Referring to FIG. 6, in the example illustrated, the dump bin 130 includes an optional fluid drainage system 180 for draining fluid waste from the dump bin 130 (e.g. for separate disposal, recycling, or reuse) while retaining solid waste for transfer to the waste receptacle. In the example illustrated, the fluid drainage system 180 comprises a drain port 182 (shown schematically in FIG. 6) at a bottom end of the dump bin 130 for draining the fluid waste. In the example illustrated, the fluid drainage system further includes a filter screen 184 (shown schematically in FIG. 6) extending across and separating an interior of the dump bin 130 into an upper portion 186a above the filter screen 184 for retaining the solid waste and a lower portion 186b below the filter screen 184 and in fluid communication with the drain port 182 for receiving the fluid waste. In some examples, the drain port 182 can comprise a valve for selectively opening and closing the port 182. In the example illustrated, the drain port 182 is connectable to a fluid recapture line 188 of a fluid recapture system 189 to recapture the fluid waste for recycling and/or reuse.

In operation, the dump-bin apparatus 100 is rolled along a ground surface via the wheel assemblies 170 to position the bin 130 in the upright position at a waste collection location (e.g. under a discharge end of a waste collection system, such as, for example, a discharge end of a conveyor along which waste is transported, such as swarf). When in position at the waste collection location, the dump bin 130 is filled with waste. In some examples, the waste can include solid waste and fluid waste. During or after filling of the dump bin 130, the fluid waste can be drained from the dump bin 130 through the drain port 182, and the solid waste can be retained in the dump bin 130. The fluid waste (e.g. metalworking fluid, such as lubricant, coolant, etc.) can be drained into the recapture line 188 of the fluid recapture system 189 for processing (e.g. filtering) and reuse (e.g. in further metalworking operations).

Referring to FIG. 8A, after the bin 130 is filled with waste, the optional fluid recapture line 188 is disconnected, and the dump-bin apparatus 100 is picked up by a forklift 190 through insertion of forks 192 into respective channels 116 of the frame 110 for transport to a waste receptacle 164.

Referring to FIG. 8B, the forklift 190 is operated to position the dump-bin apparatus 100 over an open top of the waste receptacle 164 and to lower the dump-bin apparatus 100 toward the interior of the waste receptacle 164 to bring the input end 152 of the actuator 150 (FIG. 8A) into vertical alignment with an inner surface 166 of the waste receptacle 164. In the example illustrated, the inner surface 166 is adjacent an upper edge of the waste receptacle 164 and directed away from the forklift 190 toward the interior of the waste receptacle 164.

Referring to FIG. 8C, when the input end 152 is in vertical alignment with the inner surface 166, the forklift 190 is operated in reversed to move the apparatus 100 rearwardly and bring the input end 152 of the actuator 150 into engagement with the inner surface 166 of the waste receptacle 164. This pushes the input end 152 toward the forward position which moves the latch 142 toward the unlocked position. When the latch 142 reaches the unlocked position, the bin retainer 122 is released from the frame 110 and pivots with the bin 130 under gravity from the upright position to the dumping position. Pivoting toward the dumping position inverts the bin 130 overtop of the waste receptacle 164 to dump the waste from the bin 130 into the waste receptacle 164.

After the waste is dumped from the bin 130 into the waste receptacle, the position of the bin assembly 120 is reset (to move the bin retainer 122 and bin 130 back to the upright position) for a subsequent filling and dumping cycle. The reset operation includes operating the forklift 190 to raise the apparatus 100 upwardly to bring the frame 110 and actuator 150 vertically clear of the waste receptacle 164, and reversing the forklift to bring the inverted bin 130 into engagement with the waste receptacle 164 for pivoting back to the upright position. When the frame 110 of the apparatus 100 and the forks 192 of the forklift 190 are horizontally clear of the waste receptacle 164, the apparatus 100 is lowered by the forklift with the bin 130 still in engagement with the upper edge of the waste receptacle 164 to further pivot the bin 130 upright and bring the bin retainer 122 back to the upright position, which automatically re-engages the spring-loaded release mechanism 140 to lock the bin retainer 122 and bin 130 in the upright position.

The forklift 190 is then operated to return the dump-bin apparatus 100 back to the waste collection location, and the process can be repeated for a subsequent filling and dumping cycle.

1. A dump-bin apparatus for waste transfer, comprising:
a) a frame extending along a horizontal frame axis between a front and a rear of the frame, the frame including a pair of laterally spaced apart channels extending along the frame axis, each channel having an open end at the rear of the frame for receiving a respective fork of a forklift for mounting the dump-bin apparatus to the forklift;
b) a bin retainer pivotably mounted to the frame for retaining a dump bin having an open top, the bin retainer pivotable relative to the frame about a lateral axis extending perpendicular to the frame axis between an upright position for supporting the dump bin upright with the open top directed generally upwardly for receiving waste in the dump bin, and a dumping position for inverting the dump bin to direct the open top generally downwardly for dumping the waste out from the dump bin into a waste receptacle; and
c) a release mechanism including a latch movable between a locked position for locking the bin retainer relative to the frame in the upright position and an unlocked position for unlocking the bin retainer relative to the frame to permit pivoting of the bin retainer from the upright position to the dumping position, the release mechanism including an actuator for operating the latch to unlock the bin retainer, the actuator having an input end directed rearwardly toward the forklift, the input end pushable in a forward direction toward the front of the frame through engagement with an inner surface of the waste receptacle during reverse operation of the forklift away from the waste receptacle to move the latch from the locked position to the unlocked position.

2. The dump-bin apparatus of claim 1, wherein the release mechanism is mounted to the frame, and the bin retainer has a catch interlockable with the latch when the bin retainer is in the upright position to lock the bin retainer to the frame, the latch clear of the catch when in the unlocked position to permit pivoting of the bin retainer toward the dumping position.

3. The dump-bin apparatus of claim 1, wherein the input end of the actuator has an engagement surface at an elevation below the pair of channels for lowering into the waste receptacle into vertical alignment with the inner surface of the waste receptacle.

4. The dump-bin apparatus of claim 1, wherein the input end of the actuator is rearward of the bin retainer and adjacent the rear of the frame.

5. The dump-bin apparatus of claim 1, wherein the input end of the actuator projects rearwardly from the rear of the frame.

6. The dump-bin apparatus of claim 1, wherein input end is pushable from a rearward position in which the latch is in the locked position to a forward position in which the latch is in the unlocked position.

7. The dump-bin apparatus of claim 6, wherein the release mechanism is spring-loaded and has at least one return spring biasing the latch toward the locked position and the input end of the actuator toward the rearward position to automatically reset the release mechanism when the dump bin is moved from the dumping position back into the upright position.

8. The dump-bin apparatus of claim 1, wherein the actuator has an actuator bar extending parallel with the frame axis between and connecting the input end and the latch, the actuator bar slidably coupled to the frame for sliding along the frame axis to move the latch in response to movement of the input end of the actuator.

9. The dump-bin apparatus of claim 8, wherein the latch is fixed adjacent a front end of the actuator bar and the input end is fixed adjacent a rear end of the actuator bar opposite the front end.

10. The dump-bin apparatus of claim 1, wherein when the dump bin is mounted to the bin retainer, the bin retainer and dump bin together have a center of gravity offset forward of the lateral axis to initiate pivoting of the bin retainer from the upright position toward the dumping position under gravity when the latch is moved to the unlocked position.

11. The dump-bin apparatus of claim 1, wherein the dump bin is a standard size drum.

12. The dump-bin apparatus of claim 1, further comprising a plurality of wheel assemblies projecting downwardly from an underside of the frame to facilitate transport of the dump-bin apparatus along a ground surface when dismounted from the forklift.

13. The dump-bin apparatus of claim 1, wherein the dump bin is mounted to the bin retainer, and includes a fluid drainage system for draining fluid waste from the dump bin while retaining solid waste.

14. The dump-bin apparatus of claim 13, wherein the fluid drainage system comprises a drain port adjacent a bottom end of the dump bin.

15. The dump-bin apparatus of claim 14, wherein the fluid drainage system comprises a filter screen extending across and separating an interior of the dump bin into an upper portion above the filter screen for retaining the solid waste and a lower portion below the filter screen and in fluid communication with the drain port for receiving the fluid waste.

16. A dump-bin apparatus for waste transfer, comprising:
a) a frame mountable to forks of a forklift;
b) a bin retainer pivotably mounted to the frame for securely retaining a dump bin, the bin retainer pivotable relative to the frame between an upright position for supporting the dump bin upright, and a dumping position for inverting the dump bin to dump waste out from the dump bin into a waste receptacle; and
c) a release mechanism locking the bin retainer to the frame in the upright position, the release mechanism including an actuator operable to release the bin retainer from the frame for pivoting toward the dumping position through pushing of the actuator in a forward direction away from the forklift when the frame is mounted to the forklift.

17. A method of operating a dump-bin apparatus for transferring waste to a waste receptable, the method comprising:
a) filling a dump bin of the dump-bin apparatus with waste when in an upright position through an open top of the dump bin;
b) when the dump bin is filled with the waste, operating a forklift to position the dump-bin apparatus over the waste receptacle, with the dump bin retained in the upright position by the dump-bin apparatus; and
c) after (b), operating the forklift to lower the dump-bin apparatus to align an actuator of the dump-bin apparatus with an inner surface of the waste receptacle directed away from the forklift, and reversing the forklift to bring the actuator into engagement with the inner surface and push an input end of the actuator forward relative to the dump bin to release the dump bin for pivoting from the upright position to a dumping position, in which the open top is directed downwardly to dump the waste into the waste receptacle.

18. The method of claim 17, wherein the dump bin is locked in the upright position through a latch of the release mechanism, and pushing an input end of the actuator forward unlocks the latch to permit pivoting of the dump bin from the upright position to the dumping position.

19. The method of claim 17, further comprising (d), after (c), operating the forklift to bring the dump bin into engagement with the waste receptacle to pivot the dump bin back up toward the upright position for a subsequent waste transfer cycle.

20. The method of claim 17, wherein the waste in (a) comprises solid waste and fluid waste, and prior to (b), at least some of the fluid waste is drained from the dump bin through a drain port adjacent a bottom end of the dump bin, and the solid waste is retained in the dump bin for transfer to the waste receptacle during (c).
